(19) United States
(12) Patent Application Publication
(10) Pub. No.: US 2013/0151358 A1
(43) Pub. Date: Jun. 13, 2013

(54) Network-accessible Point-of-sale Device Instance

(71) Applicant: Harsha Ramalingam, Kirkland, WA (US)

(72) Inventor: Harsha Ramalingam, Kirkland, WA (US)

(21) Appl. No.: 13/313,912

(22) Filed: Dec. 7, 2011

(51) Int. Cl. G06Q 30/06

(52) U.S. Cl. 705/16; 705/26.41

(57) ABSTRACT

One or more instances of virtual point-of-sale (POS) devices are established in the cloud for use by customers at a physical merchant location. The customers may provide payment information and an indication of the good or service they wish to purchase by using a mobile computing device at the merchant's location and to communicate with a POS device associated with the merchant location. The mobile computing device may be used to scan a tag associated with the desired good or service, the customer may enter a code representing the desired good or service, or the customer make a selection from a list of goods and/or services presented on the mobile computing device. The POS device can provide an electronic receipt to the mobile computing device which the customer may show to the merchant as evidence that the customer has paid for the good or service.

### BACKGROUND

Sellers of goods and services, merchants, may expend significant resources establishing the infrastructure necessary to receive payments from customers. Presently there is no simple and secure way to receive credit card payments at a physical merchant location without a point-of-sale (POS) device that includes a card reader. The POS device is connected to payment processors for submitting credit card payments and the device may also function as a cash register for handling other types of payments such as cash or check. The cost of acquiring and maintaining POS devices may be burdensome to merchants. Additionally, POS devices at a merchant's physical retail location may malfunction, require replacement as technology changes, and possibly commit the merchant to a relationship with a particular payment processor that may not offer the most favorable credit card processing fees.

Unlike web merchants that conduct transactions wholly over the Internet without physical connection between the customer and the merchant, brick-and-mortar merchants operating physical retail locations are not able to avoid the inconvenience and cost associated with physical POS devices. Providing brick-and-mortar merchants an option to receive credit card and other payments from customers at merchant locations without requiring actual, tangible POS devices would provide flexibility, lower costs, and greater convenience for merchants. That technology may also benefit customers by avoiding bottlenecks created by physical POS devices and encourage greater acceptance of credit cards particularly at small merchants.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows an illustrative architecture for using a network-accessible POS device from within a merchant location to make a payment with a mobile computing device.

FIG. 2 shows a diagram of interactions between the mobile computing device, the POS device, the payment processor, and the merchant shown in FIG. 1.

FIG. 3 shows the POS device from FIG. 1 in greater detail.

FIG. 4 shows an illustrative user interface for selecting a good or service from a list.

FIG. 5 shows an illustrative user interface for entering a code corresponding to a good or service.

FIG. 6 shows an illustrative user interface displaying a receipt confirming payment for a selected good or service.

FIG. 7 is a flow diagram of an illustrative process for using a mobile computing device to pay for a good or service through a network-accessible POS device.

FIG. 8 is a flow diagram of an illustrative process for receiving a selection of a good or service from a list displayed on a mobile computing device and providing a receipt to the mobile computing device once payment is confirmed.

FIG. 9 is a flow diagram of an illustrative process for receiving a scan of a tag associated with a good or service from a mobile computing device and providing a receipt to the mobile computing device as well as to the merchant.

### DETAILED DESCRIPTION

“Virtual” or cloud-based point-of-sale (POS) devices are maintained on a network-accessible computing system and made available via a network (e.g., the Internet) to computing devices at a merchant location. The cloud-based POS devices are similar to conventional POS devices that may sit on the counter of a merchant's retail location in that both types of POS devices communicate with payment processing systems such as the various payment processors for credit cards. However, unlike the card readers and other POS device hardware that may be found at a merchant location, cloud-based POS devices are not physically located at the merchant location and do not directly read information from credit cards. This disclosure describes techniques for utilizing cloud-based POS devices in conjunction with other computing devices, such as smart phones, to process in-store purchases without conventional POS device hardware.

Customers shopping at a brick-and-mortar merchant may bring their own mobile computing devices (e.g., smart phones) with them while shopping or, the merchant may lend customers mobile computing devices (e.g., a tablet computer) to use while in the store. When a customer identifies goods and/or services that he or she wishes to purchase, the customer may indicate those goods and/or services on the mobile computing device. For example, the customer may take a picture of a barcode on a good and/or service with a camera in the mobile computing device, may enter a specific code that is associated with the desired good and/or service, may browse through a catalog or a list of available goods and/or services and enter a selection, or may select a good and/or service in any other way. The mobile computing device then sends this information through a network to the cloud-based POS device. Thus, like a conventional cash register, the cloud-based POS device knows which goods and/or services the customer wishes to purchase.

The customer also provides payment information to the cloud-based POS device by using the mobile computing device. For example, the customer may enter a credit card number. If the mobile computing device is associated with the customer, a customer identifier from the mobile computing device may be used to access an online wallet that has stored credit card or other payment information for the customer. The payment information received by the cloud-based POS device is processed similar to payment information received from conventional POS equipment. After the payment information is validated and the cloud-based POS device is informed that the customer has enough money to pay for the desired goods and/or services, the cloud-based POS device generates an electronic receipt.

The electronic receipt provides evidence that a customer has paid for the goods and/or services. This receipt may be sent back to the mobile computing device that the customer used to initiate the purchase or may be sent to a computing device of a merchant. The customer may show this receipt, for example displayed on a screen of the mobile computing device, to the merchant (e.g., an employee working at the store) who then allows the customer to receive the service or take the selected good out of the store. In order to prevent forging receipts when the customer has not actually paid for the good or service, the receipt may include validation data that the merchant can examine to determine if the receipt is authentic.

Receipts may also be authenticated by providing the receipt to the mobile computing device and to a computing device that the merchant controls at the merchant location for comparison with the receipt sent to the computing device of the customer. If the merchant computing device also receives the receipt from the cloud-based POS device, the merchant can be confident that the receipt presented by the customer is authentic.

Thus, by removing the physical POS devices while still providing a mechanism for verifying payment, the merchant may eliminate checkout lines, avoid purchasing equipment, and gain flexibility. The flexibility may be gained by allowing the merchant to increase or decrease a number of POS devices at a retail location essentially instantaneously by requesting access to additional cloud-based POS device instances. Additionally, flexibility may be created by allowing the merchant to change from one cloud-based POS device provider (e.g., a bank or other financial institution) to a different cloud-based POS device provider simply by changing a contract or business relationship rather than returning one set of hardware devices and obtaining a second, different set of hardware devices.

Example implementations and context are provided with reference to the following figures, as described below in more detail. It is to be appreciated, however, that the following implementations and contexts illustrative of many possible implementations and contexts.

### Illustrative Architecture and Operation

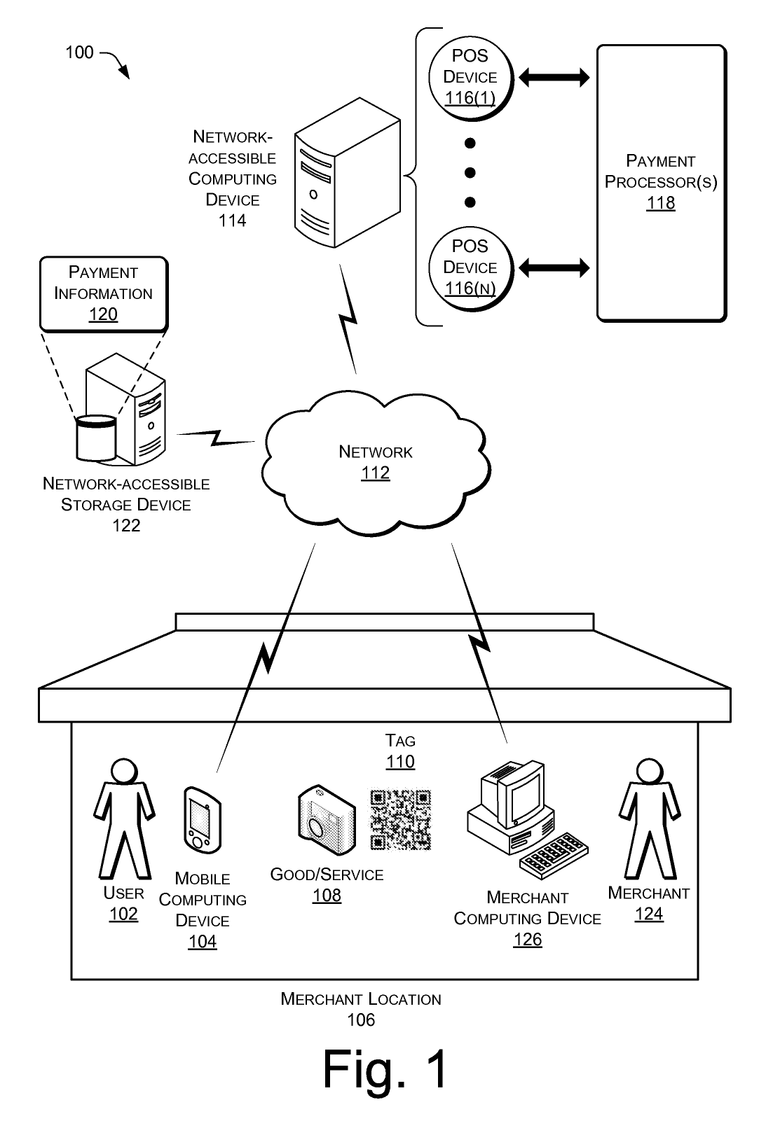

FIG. 1 shows an illustrative architecture 100 in which a user 102 (i.e., a customer) employs a mobile computing device 104 while at a merchant location 106 to purchase a good and/or service 108. The mobile computing device 104 may be implemented as any number of mobile devices, including but not limited to a mobile phone (e.g., with telephone and SMS messaging), a smart phone (e.g., with functionality to access the Internet, a mobile web, or the like), a personal digital assistant (PDA), a laptop computer, a net book, an eBook reader, a personal media player (PMP), a portable gaming system, and so forth.

Here, the good or service 108 is shown as a camera representing, for example, the camera itself (i.e., a good) or photography services (i.e., a service). This architecture 100 may be applied equally well for the purchase of any good and/or service as well as for the purchase of multiple goods and/or services. The good and/or service 108 may be associated with a tag 110 such as a barcode, a QR code, a radio-frequency identification (RFID) tag, or another kind of tag that stores information in graphical, textual, optical, electrical, magnetic, radio-frequency, or other format. The tag 110 may provide information about the good and/or service 108 such as a price, a name, product number, or other identifier of the good and/or service 108.

The user 102 may use the mobile computing device 104 to read the tag 110 in order to provide information about the good and/or service 108 to the mobile computing device 104. However, in alternate implementations the user 102 may type in a code that is associated with the good and/or service 108 and the mobile computing device 104 may use this code to obtain information about the good and/or service 108. In alternate implementations, the user 102 may browse through a list or catalog of goods and/or services 108 on the mobile computing device 104 and select the one he or she wishes to purchase from the list.

This information may be provided from the mobile computing device 104 via a network 112 to a network-accessible computing device 114 that contains one or more instances of cloud-based POS devices 116(1)-116(n). The network 112 may include any one or combination of multiple different types of networks, such as cable networks, local area networks, personal area networks, wide area networks, the Internet, wireless networks, ad hoc networks, mesh networks, and/or the like. The mobile computing device 104 may access the network 112 through a wired or wireless connection such as a connection using radio signals (e.g., Wi-Fi, Bluetooth®, 3G network, 4G network, etc.).

The network-accessible computing device 114 may be, for example, a server computer. Each of the multiple instances of the cloud-based POS devices 116(1)116(n) may correspond to a “virtual” representation of a single piece of hardware that functions as a POS device. Thus, the cloud-based POS devices 116(1)-116(n) may each be uniquely and specifically assigned to a pre-specified merchant location 106 and each may exchange information with one or more payment processors 118. The number of POS device instances may be varied based on the capabilities of the network-accessible computing device 114 and the demands of merchants using these cloud-based POS devices 116. Thus, additional instances of a cloud-based POS device 116 may be rapidly brought online by modifying hardware and/or software of the network-accessible computing device 114.

The payment processors 118 may be accessed over a public network such as the Internet or a private or limited-access network that provides access to one or more gateway providers for processing and routing payments to the appropriate payment processor based on the type of payment. This may be similar or identical to the system that supports conventional POS devices by routing, for example, Visa® charges to the bank that issued the credit card, Discover® charges to the Discover® payment processor, and the like. Information may be sent to the payment processor 118 using specific application programming interfaces (APIs) associated with each of the payment processors 118. For example, the APIs for submitting Visa® charges may be different than the APIs for submitting Master Card® charges. Thus, the payment processor 118 and the corresponding APIs may be identified by the form of payment. After the payments are reconciled against the appropriate one of the payment processors 118, the one of the cloud-based POS devices 116(1)-116(n), hereinafter referred to as POS device 116, that is linked to the merchant location 106 may receive a response such as an indication that the transaction is authorized or declined.

The POS devices 116 may also be used to track cash transactions. The merchant 124 may enter cash transactions into the merchant computing device 126 which communicates the transaction information to one of the POS devices 116 via the network 112. In this case, communication between the POS device 116 and the payment processors 118 is not necessary since payment was made in cash. However, use of the POS device 116 to record all transactions including cash transactions may provide unified accounting and inventory management functionality similar to that of conventional hardware POS devices.

In some implementations, the mobile computing device 104 may be location aware, or is able to provide information to another entity (e.g., a network-accessible server) to allow the other entity to determine a location of the mobile computing device 104. A location on the surface of the earth, or a “geolocation,” may be provided to the mobile computing device 104 by a satellite such as a global positioning system (GPS) satellite. Alternatively, wireless signals such as from a radio antenna may be used to determine a geolocation of the mobile computing device 104 relative to a known position of the radio antenna or by triangulation. Other technologies and methods for determining geolocation are also envisioned within the scope of this disclosure such as, for example, calculating geolocation based on a network access point (e.g., Wi-Fi hotspot) or from a locator signal broadcast from a known location such as inside a merchant. The geolocation of the mobile computing device 104 may be used to validate the purchase by confirming that the mobile computing device 104 is located at or near (e.g., within a threshold distance) the merchant location 106 at the time the user 102 attempts to purchase the good and/or service 108.

Payment information 120 of the user 102 may be stored in a memory of the mobile computing device 104 and provided to the POS device 116 via the network 112. Alternatively or additionally, payment information 120 may also be stored in a network-accessible storage device 122 such as an online account or “virtual” wallet. The payment information 120 in the network accessible storage device 122 may be associated with the user 102 by a user identifier (ID) sent from the mobile computing device 104. The user ID may be a combination of a user name and/or password, a serial number of the mobile computing device 104, or some other unique identifier of the user 102.

The merchant 124 at the merchant location 106 represents an employee, contractor, owner, partner, or other person associated with the enterprise operating at the merchant location 106. The merchant 124 may be responsible for confirming that the user 102 receives the good or service 108 only after paying for the good or service 108. The merchant 124 may inspect a receipt sent from the POS device 116 and displayed on the mobile computing device 104 as evidence that the user 102 paid for the good or service 108. A merchant computing device 126 may also receive a receipt from the POS device 116 showing that the user 102 paid for the good or service 108. In some implementations, the receipt received by merchant computing device 126 may be similar or identical to the receipt received by the mobile computing device 104. By comparing the two receipts the merchant 124 can confirm the authenticity of the receipt displayed on the mobile computing device 104 and confirm that the user 102 who actually paid, as opposed to another user, receives the good or service 108.

The merchant computing device 126 may be any type of computing device such as a desktop computer, a laptop computer, a tablet computer, a smart phone, a personal digital assistant, and the like.

In summary, shifting POS device functionality to the cloud simplifies operation of the merchant location 106 while providing a mechanism for accepting credit card, debit card, gift card, and other types of payments. The merchant 124 may still choose to maintain tangible equipment for managing sales at the merchant location 106 such as the merchant computing device 126 and/or mobile computing devices 104 that are loaned to customers. However, both the merchant computing device 126 and the mobile computing device 104 may be general purpose computing devices that are adapted to function with this payment system through the use of software (e.g., specialized payment “apps,” a standard browser accessing a web-based application, etc.). These types of computing devices may be easier for the merchant to acquire, modify, and maintain than a special purpose POS device.

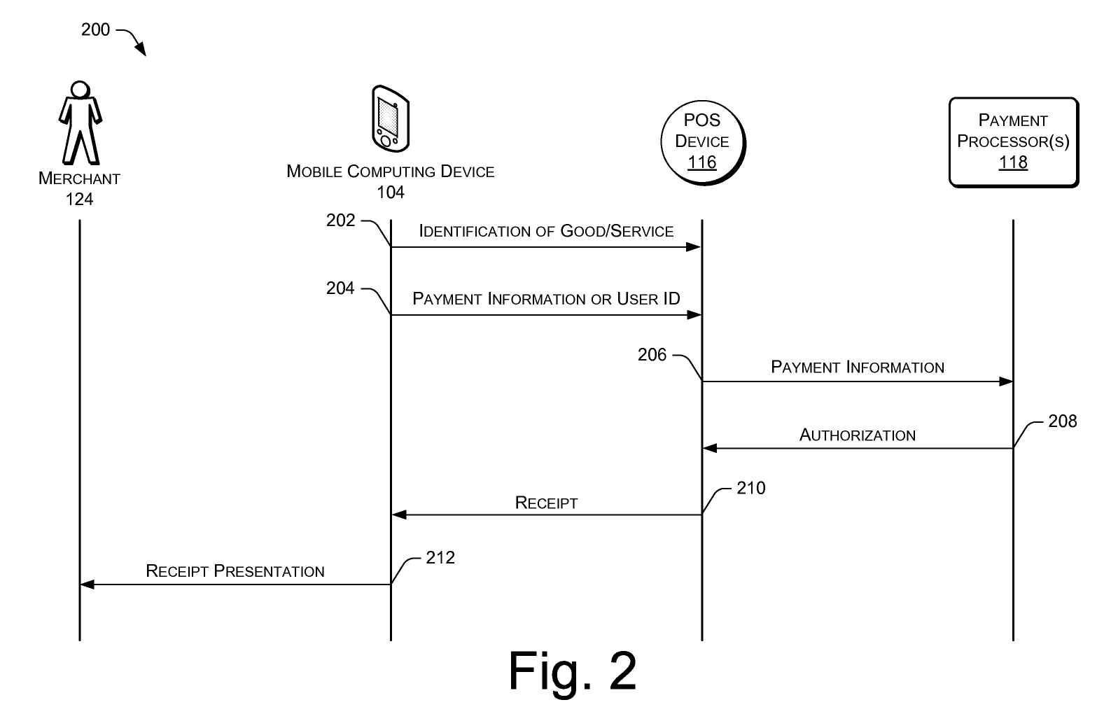

FIG. 2 shows a diagram 200 of interactions between the mobile computing device 104, the POS device 116, the payment processor 118, and the merchant 124 of FIG. 1. At 202, the mobile computing device 104 identifies one or more goods and/or services 108 to the POS device 116. The identification may provided on an item-by-item basis, for example, as a customer moves through a store and puts various items in a shopping cart he or she can also use the mobile computing device 104 to separately indicate each item in turn. The identification may also be provided as a batch, for example, the customer may enter multiple items in the mobile computing device 104 at the same time such as by selecting each of the items in his or her shopping cart from a catalog displayed on the mobile computing device 104.

At 204, payment information is sent to the POS device 116. The payment information may be sent directly from the mobile computing device 104 in response to the user 102 entering the payment information into the mobile computing device 104 or by sending previously stored payment information from a memory of the mobile computing device 104. Alternatively, the mobile computing device 104 may supply a user ID that is associated with payment information available on a network (e.g., web-based user account with associated payment information) and the payment information from network is in turn provided to the POS device 116.

At 206, payment information and an indication of the requested amount of money received by the POS device 116 is in turn forwarded to a payment processor 118. The payment processor 118 may be any type of conventional payment processor that interacts with existing POS device hardware. For example, the payment processor 118 may be a clearinghouse that processes checks or electronic checks, the bank that issued a credit card, a server computer that administers a type of electronic currency, or the like. Once the payment processor 118 receives the payment information, the payment processor 118 may submit the debit for reconciliation from the appropriate account and determine if there are sufficient funds from which to subtract the debit.

At 208, the payment processor 118 may provide authorization to the POS device 116. The authorization may be based on a determination made by the payment processor 118 that an account associated with the payment information 120 has sufficient funds to pay for the good or service 108. The payment processor 118 may also determine that sufficient funds are not available and decline the transaction. Upon receiving an authorization from the payment processor 118, the POS device 116 may generate a receipt for the transaction. Since the POS device 116 is cloud-based rather than a tangible piece of equipment at the merchant location 106, the receipt may be an electronic receipt. The electronic receipt, hereinafter it simply “receipt,” may be transmitted through e-mail, SMS, or other electronic communication channels. In some implementations, the POS device 116 or a printer associated with the network-accessible computing device 114 may generate a printed hardcopy receipt. The printed hardcopy receipt may be maintained for auditing purposes and/or later mailed to the merchant and/or customer.

At 210, the POS device 120 provides the receipt to the mobile computing device 104. The POS device 120 may also provide the receipt to the merchant computing device 126. The mobile computing device 104 may store the receipt in memory, display the receipt on a display screen, or otherwise present the receipt to the user 102. For example, the mobile computing device 104 may use output technology other than a display, such as audio, for communicating the receipt to a user.

At 212, the receipt on the mobile computing device 104 is presented to the merchant 124. This may include the user 102 showing the display of the mobile computing device 104 to the merchant 112 as the user 102 leaves the merchant location 106 with the purchased good 108. In some implementations, the merchant 124 may compare the receipt provided by the user 102 with a receipt displayed on the merchant computing device 126.

### Illustrative Point-of-Sale Device

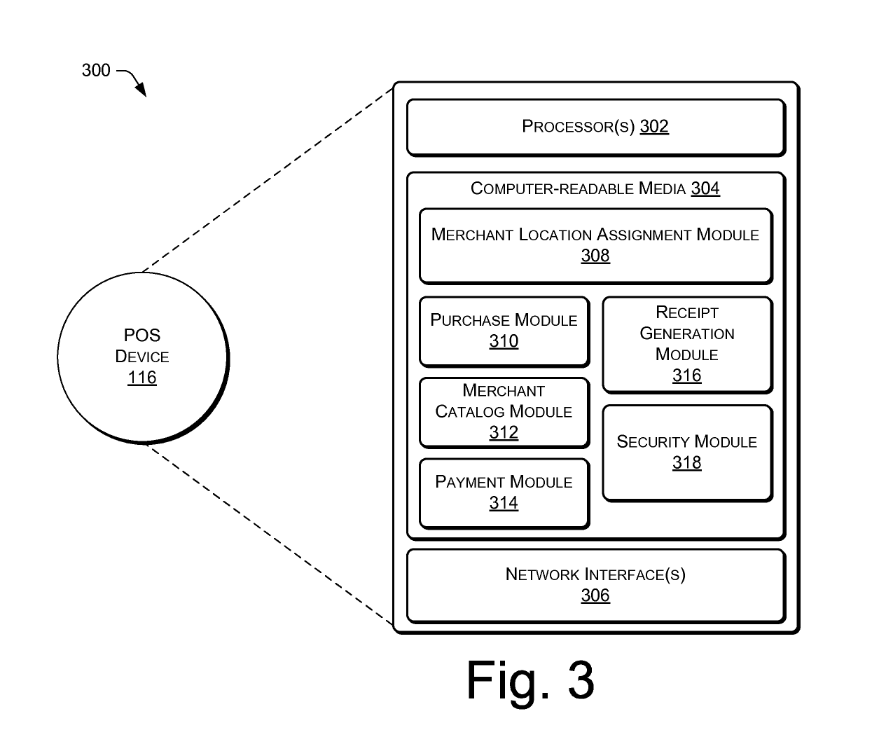

FIG. 3 is a schematic representation of the POS device 116 of FIG. 1. The POS device 116 may be implemented as a “virtual” instance of a POS device on the network-accessible computing device 118. The POS device 116 comprises one or more processors 302 and one or more forms of computer-readable media 304. The computer-readable media 304 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer-readable medium which can be used to store information and which can be accessed by a processor. The POS device 116 also includes one or more network interfaces 306 for communicating with network 116 and the payment processor 118. The network interfaces 306 may provide network connectivity through any wired or wireless technology such as a phone line, Ethernet, coaxial cable, Bluetooth®, Wi-Fi, or the like.

The memory 304 may contain one or more modules representing computer-executable instructions that may be executed on the one or more processors 302. One illustrative module is a merchant location assignment module 308. The merchant location assignment module 308 associates the POS device 116 with a single merchant location 106 remote from a physical location of the POS device 116. The POS device 116 may be a great distance away from the merchant location 106 and connected by the network 112. However, the merchant location assignment module 308 may exclusively associate the POS device 116 with only the single merchant location 106. Thus, although the architecture 100 shown in FIG. 1 allows great flexibility in assigning the POS device 116 to many different merchants, once assigned the POS device 116 may be linked to a specific merchant location 106 analogous to the association between a tangible POS device located at a checkout counter and the physical location of the store in which the POS device is located. Thus, the cloud-based POS device 116 may be implemented as if it is located “at” a specific merchant location 106. The correlation between the POS device 116 and the merchant location 106 may provide advantages for accounting, inventory management, and the like. Merchants may also receive lower processing fees from payment processors 118 that offer lower fees for on-premise transactions as compared to remote transactions not tied to a location such as purchases made over the Internet or phone.

The flexibility available by providing an instance of a POS device 116 through a network 112 allows for a merchant to increase or decrease the number of POS devices 116 at a merchant location 106 as needed. For example, the merchant may request additional POS devices 116 for its store locations during a holiday shopping season. When the additional POS devices 116 are no longer needed because shopping volumes have decreased, the merchant may release those POS devices 116 for use by other merchants. In some business arrangements with a provider of cloud-based POS devices 116, fees paid by the merchant may be based on the number of POS devices 116 used, so there would be a financial incentive to use additional POS devices 116 only when necessary. Thus, the merchant location assignment module 308 may associate the POS device 116 with the merchant location 106 for a time period based at least in part on a volume of transactions occurring or estimated to occur at the merchant location 106 during the time period. The change in number or capacity of POS devices 116 associated with a merchant location 106 may happen automatically in response to a changing transaction volume. For example, to save POS device fees a merchant may choose to have only one POS device 116 associated with a given merchant location 106, but when transaction volumes at that merchant location 106 approaches the capacity of the POS device 116, an additional POS device 116 may be automatically assigned to that merchant location 106.

The POS devices 116 may also be able to be locked down by the merchant and the merchant may be able to fully configure and control the POS devices 116 while the merchant is using those devices. The merchant location assignment module 308 may also establish a secure connection between the POS device 116 and a merchant network maintained by a merchant operating the merchant location 106 so that the POS device 116 functions as a part of the merchant network. In some implementations, the POS device 116 may therefore be effectively added as a part of a corporate network of the merchant.

A purchase module 310 may receive, via the network connection 306, a purchase request from a customer-operated device, such as the mobile computing device 104, located at the merchant location 106. The purchase request may include payment information 120 and identification of a good or service 108 that a customer wishes to purchase. The payment information may include payment information 120 entered by a user 102 of the customer-operated device at a time of the purchase (e.g., typing in a credit card number), payment information 120 previously stored in a memory of the customer-operated device (e.g., a bank routing number and checking account number stored in a mobile computing device 104), or payment information 120 available via the network 112 (e.g., a merchant gift card account balance) and associated with the customer-operated device by a user identifier stored 120 in a memory of the customer-operated device. Identification of the good or service 108 may be provided by a scan of a tag 110 associated with the good or service 108. The scan may be produced by the customer-operated device using an input or a sensing component of the customer-operated device such as using a camera to take a picture of a barcode or the item, or using an antenna to receive a radio signal from an RFID tag. The picture of the barcode or item may be analyzed using machine vision to find a matching item in the merchant's catalog of goods and/or services. The good or service 108 may also be identified by selection of the good or service 108 from a list displayed on the customer-operated device such as a menu from a restaurant, a catalog of goods or services, and the like. Alternatively, the user 102 of the customer-operated device may enter a code that corresponds to one or more goods and/or services 108.

A merchant catalog module 312 may store all or part of the merchant's catalog of goods and/or services on the POS device 116. The merchant catalog module 312 may include identifying information for each good and/or service in the catalog such as a name, product number, bar code value, or the like. The merchant catalog module 312 may also include a price for goods and/or services in the catalog. The contents of the merchant catalog module 312 may be associated with the merchant location 106 that is assigned to the POS device 116 by the merchant location assignment module 308. The merchant catalog module 312 may also provide inventory accounting by tracking purchases and inventory available at the merchant location 106. In some implementations, the merchant catalog module 312, may be located in whole or part somewhere other than the POS device 116 such as, for example, in the network-accessible storage device 122 shown in FIG. 1.

A payment module 314 may provide payment information to the payment processor 118 and receive an authorization from the payment processor 118 to fulfill the purchase request. The payment module 314 may use encryption similar to or superior to that used by conventional hardware POS devices when transmitting the payment information.

A receipt generation module 316 generates a receipt evidencing the authorization from the payment processor 118. The receipts may also identify the good or service 108. In some implementations, the receipt generation module 316 sends the receipt to the customer-operated device. Thus, the receipt provides confirmation to the user 102 that his or her purchase was successfully completed. As a technique to thwart people who may try to forge receipts without actually paying for the goods or services 108, the receipt may include validation data. The validation data may be based on seed information provided by the merchant associated with the merchant location 106. The seed information itself may be difficult to reverse engineer by examination of the receipt, but the merchant may be able to readily identify absence of the correct seed information by examination of a forged receipt. An additional layer of security to prevent forged receipts may include changing the seed information at a frequency specified by the merchant such as, for example, every hour or every day.

In other implementations, the receipt generation module 316 may send the receipt to the customer-operated device and to a computing device of the merchant 126 at the merchant location 106. Receiving the receipt at the merchant computing device 126 from the POS device 116, rather than through a computing device controlled by a customer, provides an alternative or additional technique for preventing people with forged receipts from receiving goods and/or services 108 without paying.

A security module 318 may receive an indication of a location of the customer-operated device, compare the location of the customer-operated device to the merchant location 106, and when the location of the customer-operated device is more than a threshold distance from the merchant location 106, prevent the customer-operated device from completing a purchase. Requiring correlation between the geolocation of the customer-operated device and the merchant location 106 may prevent fraudulent or mistaken transactions. For example, with this location-based security implemented it may be more difficult for a customer's smart phone to be inadvertently or fraudulently charged for transactions that he or she did not initiate. This technique may also prevent the POS device 116 from receiving incorrect or fraudulent transaction requests sent from computing devices outside of the merchant location 106.

### Illustrative User Interfaces

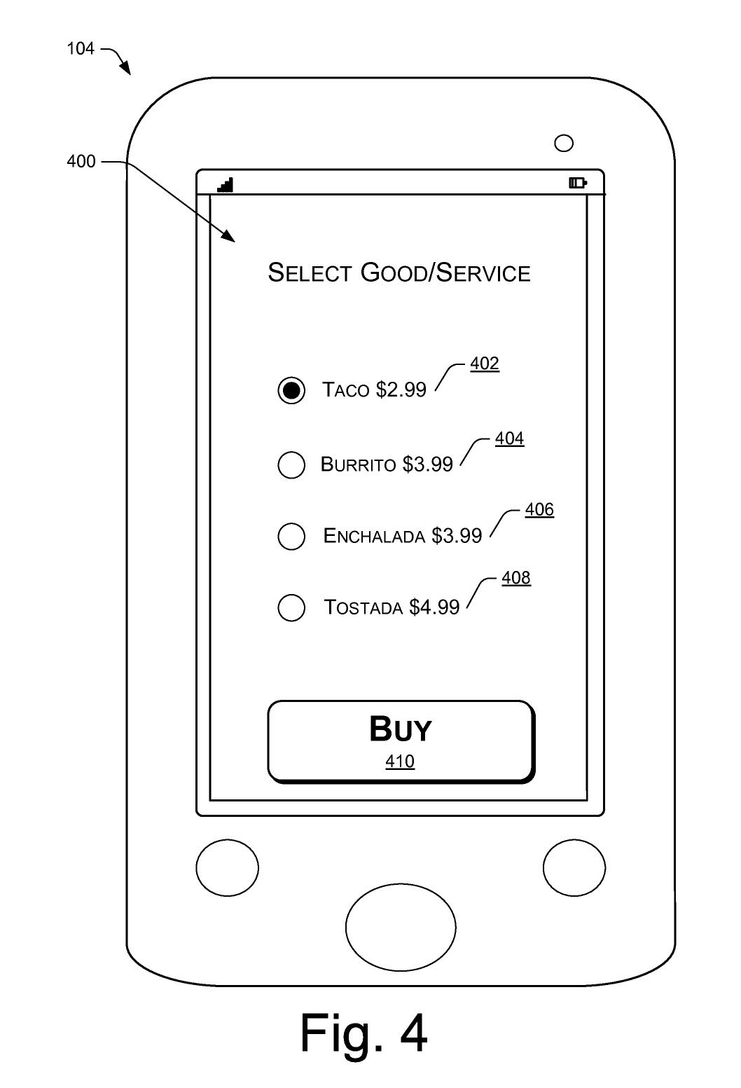

FIG. 4 shows an illustrative user interface 400 of the mobile computing device 104 providing a menu for the user 102 to select a good or service 108. In this example, the merchant is a restaurant selling Mexican food. The menu provides four different food choices a taco 402, a burrito 404, an enchilada 406, and a tostada 408. For each good or service 108 presented on the user interface 400, the menu may show a name, a description, a price, and the like. In this example user interface 400, the user 102 may select one or more of the choices by pressing a radio button next to his or her selection. Of course, this example is merely illustrative and the menu may have a greater or lesser number of items, and may be used to represent services for sale as well as other types of non-food goods. Once the user 102 has used the user interface 400 to indicate the goods and/or services 108 he or she wishes to buy, the user 102 may press the “Buy” button 410 to transmit the selection and payment information to the POS device 116.

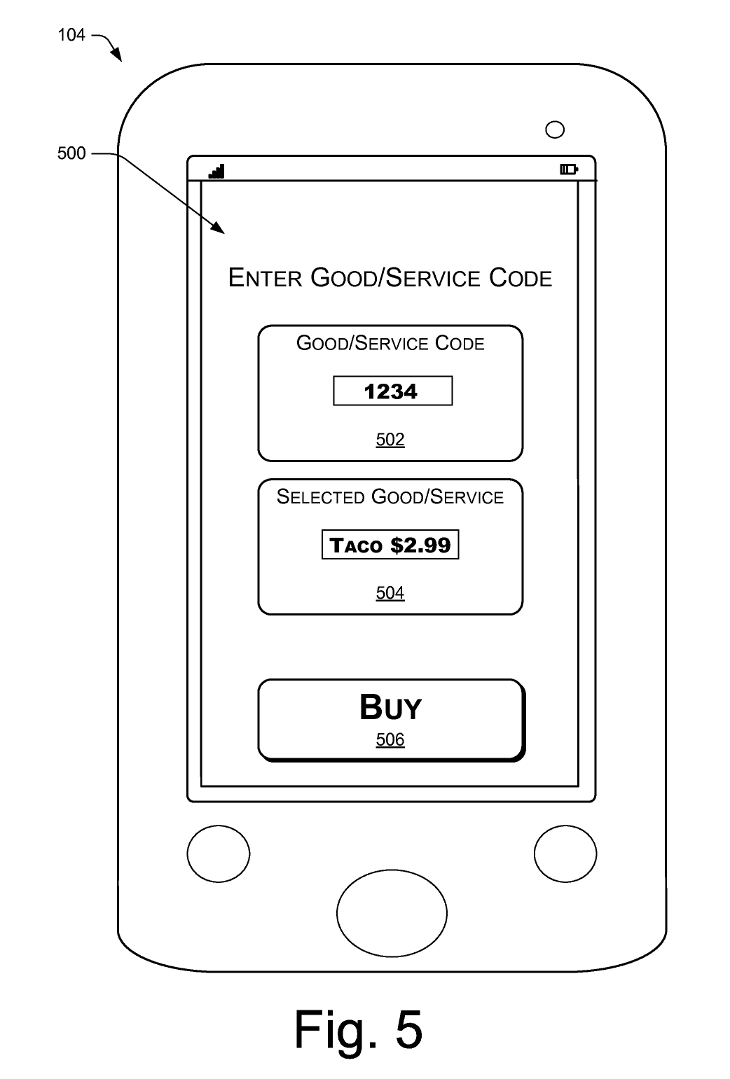

FIG. 5 shows an illustrative user interface 500 of the mobile computing device 104 providing a field 502 for the user 102 to enter a code associated with a good or service 108. For example, the restaurant selling Mexican food may have a conventional printed menu that lists codes next to the menu items. The user 102 may identify the code that corresponds with the good or service 108 he or she wishes to purchase and enter that code into the goods/service code field 502. In order to reduce the possibility of mistakenly entering the wrong code, the user interface 500 may also included a confirmation field 504 that shows the selected good and/or service 108 which corresponds with the code. Thus, if the user 102 enters the wrong code he or she will be able to identify that by examining the confirmation field 504. After the user has entered the code and confirmed that the code is correct, he or she may press the “Buy” button 506. Pressing the “Buy” button 506 may transmit the selection and payment information to the POS device 116.

The code may also be generated for a specific good or service 108 or combination of goods and services 108 purchased by the user 102. For example the code may be printed on a paper bill or invoice and the code is identified by the POS device 116 as corresponding to the particular bill or invoice and the code correlates with the amount of the payment for that bill or invoice. The confirmation field 504 may show the amount that will be charged and the user 102 can compare this amount to the amount appearing on the bill or invoice. If it is correct, the user 102 may press the “Buy” button 506. As one example, a restaurant could give diners a bill with a claim code that is associated with the total charge for the meal and this claim code could be entered into the goods/service code field 502.

Purchases of goods and/or services 108 that may require preparation by the merchant (e.g., cooking the taco) may also include a communication from the mobile computing device 104 responsive to the pressing of the “Buy” button 506 alerting the merchant of the purchase. The communication may be sent first to POS device 116 and then to the merchant or directly to the merchant such as to the merchant computing device 126. This communication informs the merchant of what was purchased and gives the merchant notice that the good or service 108 must be prepared for the customer. Thus, the POS device 116 and supporting architecture 100 shown in FIG. 1 may also provide an ordering functionality by telling the merchant what has been purchased and thereby allowing the merchant to prepare the good or service for sale.

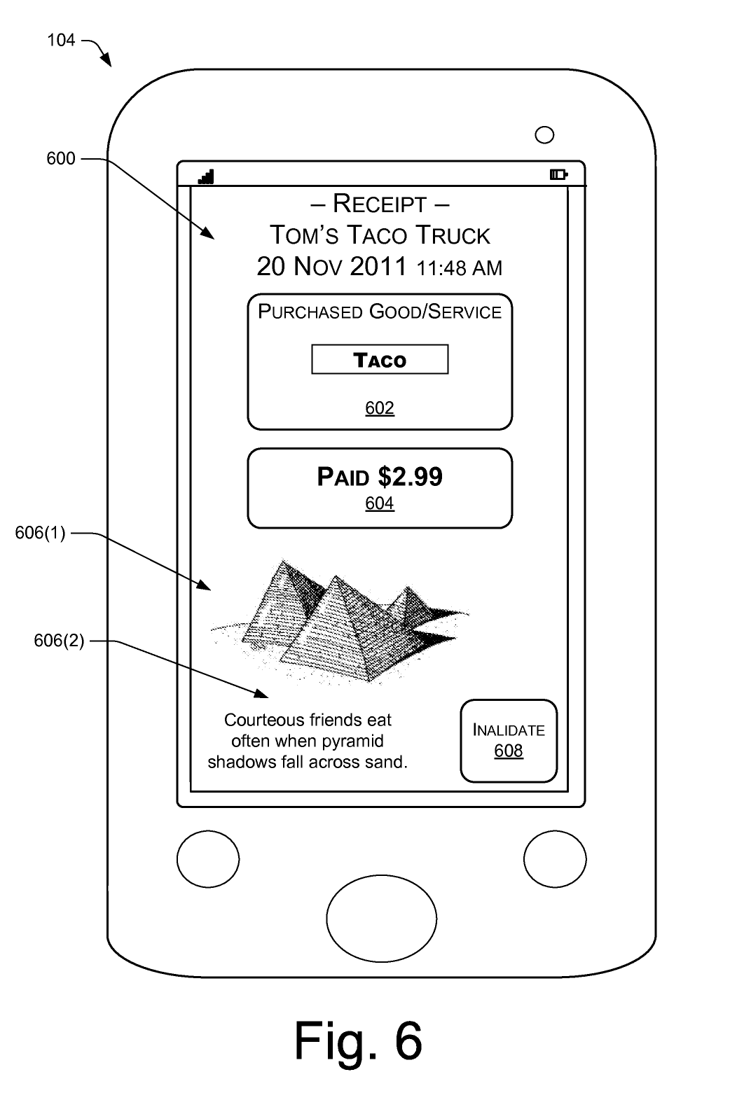

FIG. 6 shows an illustrative user interface 600 on the mobile computing device 104 displaying a receipt. The electronic receipt displayed on the user interface 600 may include the name of the merchant, a date, a time, and any other information found on a conventional printed receipt. The user interface 600 showing the receipt identifies the good and/or service 108 that was purchased 602. When the receipt is shown to the merchant, the merchant will know which good or service 108 to provide to the customer. The merchant can check that the customer is not trying to take additional goods and/or services 108 that were not purchased. The receipt may also indicate the status of the good or service 108 as being “paid” 604 and show the amount of the payment.

In some implementations, the receipt may include validation data 606 that can be examined by the merchant to confirm that the receipt is authentic. As a basic example, the validation data 606 may consist of a validation image 606(1) added to the receipt by the POS device 116. Here, the validation image 606(1) is a pyramid. An identical pyramid image may be used on every receipt. However, a forged receipt may be created relatively easily once the validation image 606(1) is known. More sophisticated techniques may be employed such as by using a large number of images that each include different forms of the validation image 606(1). For example, the validation image 606(1) may be a pyramid and each receipt may have a different picture of a pyramid. Although the validation image 606(1) shown in the example user interface 600 is clearly an image of a pyramid, the validation image 606(1) may be a relatively minor component of the total image, and thus, more difficult for a potential thief to discern from the image that appears on the receipt. For example, the image shown in this user interface 600 may also be a validation image 606(1) for shadows, sand, or triangles. Thus, the merchant 124 checking receipts may know to look for pictures that include a specific element (e.g., pyramid, sand, shadow, etc.) which may make it easy for the merchant 124 to quickly identify a receipt as having the correct validation image 606(1) or not. The validation image 606(1) may also require a combination of two or more features such as shadows and sand.

Validation text 606(2) may be used instead of or in addition to the validation image 606(1). The validation text 606(2) may be random words or words strung together in a sentence. There may be specific, predetermined words that are included in the validation text 606(2). However, without examining a relatively large number of receipts it may be difficult for a thief to determine which word or words are used to validate the receipt. For example, the required word in the validation text 606(2) shown in the user interface 600 could be “pyramid,” “shadows,” “sand,” or any of the other words. If the merchant 124 knows which word or words to look for when reviewing receipts, it is relatively easy for him or her to identify forged receipts that lack the validation text 606(2). The ability to use validation text 606(2) allows for authentication of text-only receipts that may be received and displayed on mobile phones that lack all the features of a smart phone, but are able to receive text messages.

The words and/or images required to appear in the validation data 606 may be seeds or keys provided by the merchant to the POS device 116 and used by the receipt generation module 316 to generate a receipt with the validation data 606. For example, the merchant may set the seeds as “pyramid” and “shadows” for a given day and the POS device 116 will generate receipts with validation images 606(1) and/or validation text 606(2) that include the seeds.

The receipt may also include an invalidate button 608 that the merchant 124 may activate to invalidate the receipt. Invalidating the receipt may prevent re-use of a receipt to receive multiple goods and/or services 108 for a single payment. Invalidation of the receipt may cause the mobile computing device 104 to communicate the invalidity to the POS device 116 for tracking and security purposes. In some implementations, the merchant 124 may enter a code into the mobile computing device 104 to invalidate the receipt. This may prevent the user 102 from accidentally invalidating the receipt before receiving the purchased good or service 108. Receipts may also become invalidated by the passage of time (e.g., a receipt may only be valid for 24 hours and then expire even the invalidate button 608 is not pressed.

### Illustrative Processes

These processes discussed below are each illustrated as a collection of blocks in a logical flow graph, which represent a sequence of operations that can be implemented in hardware, software, or a combination thereof In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

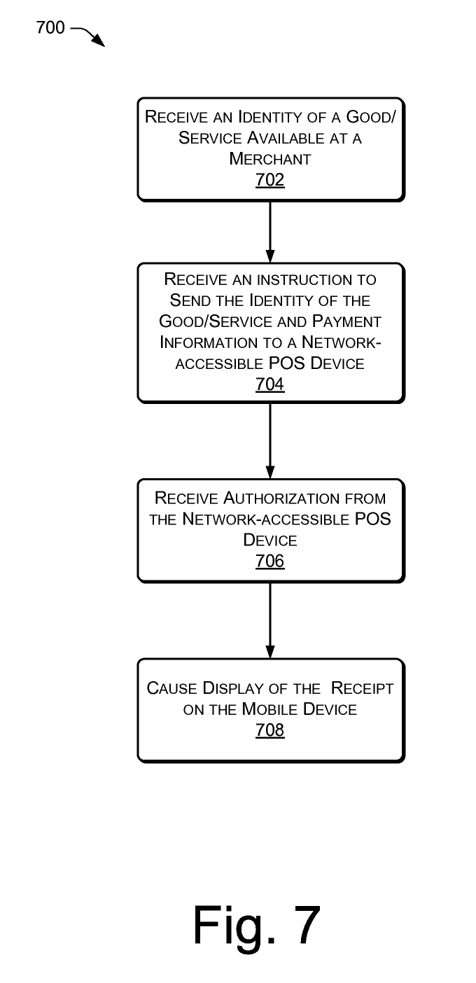

FIG. 7 is an illustrative process 700 for a mobile computing device 104 to facilitate purchase of a good or service from a merchant using a POS device 116. At 702, an identify a good or service 108 available from a merchant 124 at the merchant location 106 is received from a user 102 of the mobile computing device 104 while the mobile computing device 104 is at the merchant location 106. The identity may be provided by an image of a tag 110 associated with the good or service 108 that is captured using a camera of the mobile computing device 104. The mobile computing device 104 may be, but is not limited to, a mobile phone, a smart phone, a tablet computer, a personal digital assistant (PDA), or the like.

At 704, an instruction to send via the network 112 the identity of the good or service 108 and payment information 120 to a network-accessible POS device 116 associated with the merchant location 106 and located remote from the merchant location 106 is received from the user. The network 112 may be in whole or part a wireless network (e.g., Bluetooth®, Wi-Fi, etc.).

At 706, authorization to sell the good or service 108 to the user 102 is received from the POS device 116. The authorization may be based on the payment information provided at 704.

At 708, the receipt is displayed on the mobile computing device 104 in response to receiving the authorization at 706. The receipt is received via the network 112 from the POS device 116 and indicates receipt of payment for the identified good or service 108. The receipt, when displayed to the merchant 124 and validated by the merchant 124 may result in the merchant 124 allowing the user 102 to receive the good or service 108 from the merchant 124. Validation may include the merchant 124 simply identifying that the customer has a receipt. Validation may also include the merchant 124 checking validation data included on the receipt and/or matching the receipt to a receipt displayed on the merchant computing device 126. In some implementations, the receipt may be displayed to the merchant 124 at an exit of the merchant location 106 or the receipt may be displayed to the merchant 124 when the customer requests the good or service 106 from the merchant 124.

The user 102 of the mobile computing device 104 may select the timing of displaying the receipt. He or she may display the receipt to the merchant 124 at any time after receiving the receipt from the POS device 116. The user 102 can then receive the good or service 108 from the merchant 124 at substantially the same time. For example, after selecting a good 108 at the merchant location 106 and paying for the good 108, the user 102 may take the good 108 to an exit of the merchant location 106 and leave with the good 108 immediately after displaying the receipt to the merchant 124. As an additional example, the user 102 may select and pay for a service 108 and then, after displaying the receipt, receive the service 108 from the merchant 124 as soon as the merchant 124 can provide the service. Thus, paying with the POS device 116 does not necessarily introduce any delays beyond those that might be experienced by a customer paying with cash.

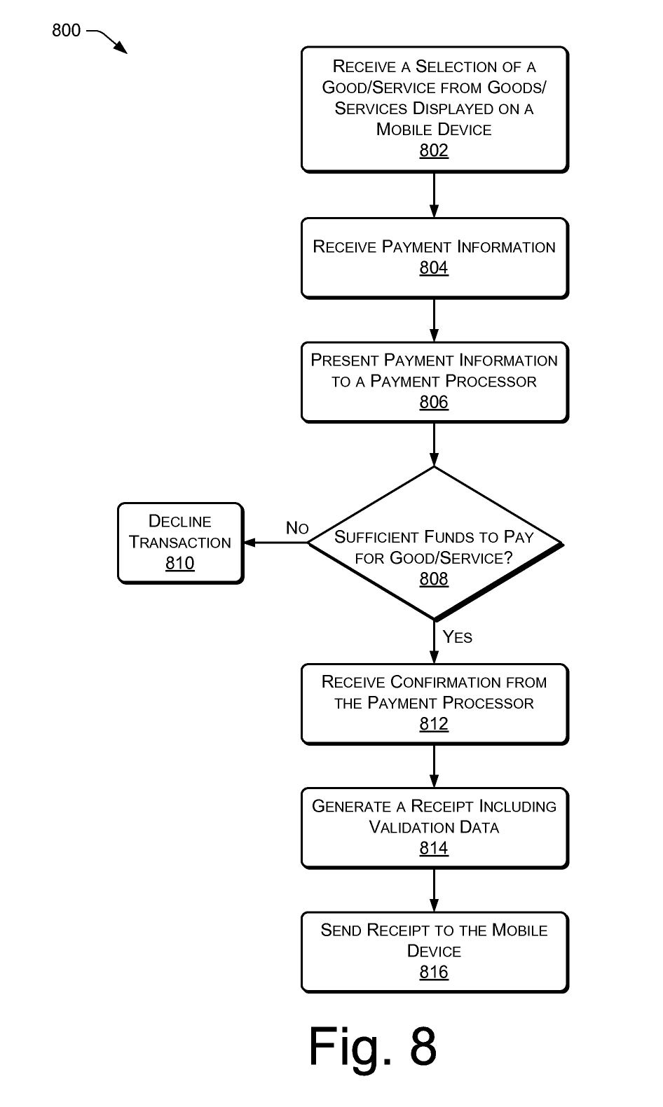

FIG. 8 is an illustrative process 800 for processing a transaction initiated by a user selecting a good or service 108 from a list displayed on a mobile computing device 104. At 802, a selection of a good or service 108 from the goods and services available at the merchant location 106 is received. The goods and services available at the merchant may be displayed as a list on a mobile computing device 104 in a user interface such as the user interface 400 shown in FIG. 4. The selection may be made by a user 102 of the mobile computing device 104 while the user 102 and the mobile computing device 104 are located at the merchant location 106. For example, the user 102 may select a taco from the list while standing in front of a taco truck.

Geolocation of the mobile computing device 104 may be used to identify the correct list of goods and services to display on the mobile computing device 104. For example, the list of goods and services of the merchant location 106 closest to the detected location of the mobile computing device 104 may be presented. The location of the mobile computing device 104 may also be identified by the user 102 supplying location information such as entering a postal code, typing in an address, or selecting a location on a map. Thus, correlation between the location of the mobile computing device 104 and the merchant location 106 may be accomplished with user input for devices that are not location aware.

At 804, payment information 120 is received from the mobile computing device 104. The payment information 120 may be entered by the user 102 into the mobile computing device 104 to pay for the good or service 108. For example, the user 102 may type in his or her credit card number.

At 806, the payment information 120 is presented to a payment processor 118.

At 808, the payment processor 118 determines if there are sufficient funds in an account associated with the payment information 120 to pay for the good or service 108. If there are not sufficient funds, process 800 proceeds along the “no” path to 810 and the transaction is declined. If there are sufficient funds, process 800 proceeds along the “yes” path to 812.

At 812, confirmation is received from the payment processor 118 that the payment information 120 is associated with sufficient funds to pay for the good or service 108.

At 814, a receipt is generated. The receipt may include validation data 606, such as that shown in FIG. 6, which is based at least in part on seed information provided by the merchant 124 operating the merchant location 106. The receipt may also include an indication of the good or service 108 that was selected at 802.

At 816, the receipt is sent to the mobile computing device 104. The user 102 of the mobile computing device 104 may display the receipt to the merchant 124 as evidence of payment for the good or service 108.

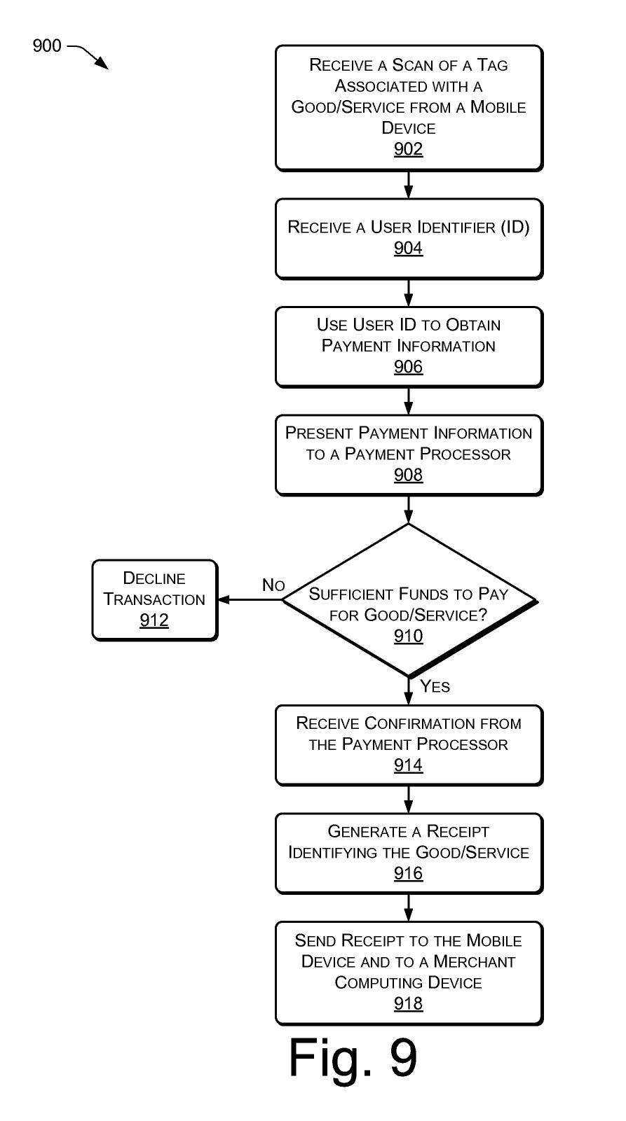

FIG. 9 is an illustrative process 900 for processing a transaction initiated by a user 102 scanning a tag 110 associated with a good or service 108 by using a mobile computing device 104. At 902, a scan of a tag 110 associated with a good or service 108 available at a merchant location 106 is received. The scan 110 may be generated by a mobile computing device 104 while a user 102 of the mobile computing device 104 and the mobile computing device 102 are located at the merchant location 106. For example, the user 102 may place his or her smart phone in scan mode and pass the smart phone near an RFID tag inside product packaging to scan the desired good 108.

At 904, a user identifier (ID) that uniquely identifies the user is received from the mobile computing device 104. The user ID may be specific to the individual user 102 (e.g., “John”), specific to the mobile computing device 104 (e.g., John's smart phone), or associated with a particular merchant (e.g., John's account with Merchant X).

At 906, the user ID is used to obtain previously stored payment information 120 associated with the user 102 to pay for the good or service 108. For example, the payment information 120 may be stored on the network or in the cloud on a network-accessible storage device 122 that links the user ID with one or more sets of payment information 120 (e.g., four different credit cards of the user 102).

At 908, the payment information 120 is presented to a payment processor 118.

At 910, the payment processor 118 determines if there are sufficient funds in an account associated with the payment information 120 to pay for the good or service 108. If there are not sufficient funds, process 900 proceeds along the “no” path to 912 and the transaction is declined. If there are sufficient funds, process 900 proceeds along the “yes” path to 914.

At 914, confirmation from the payment processor 118 that the payment information 120 is associated with sufficient funds to pay for the good or service 108 is received.

At 916, a receipt is generated that identifies the good or service 108 in response to receiving the confirmation at 914. The receipt may also, optionally, identify an amount paid for the good or service and/or validation data.

At 918, the receipt is sent to the mobile computing device 104 and to a merchant computing device 124. Matching the receipt on the mobile computing device 104 with the receipt on the merchant computing device 124 provides evidence of payment for the good or service 108. Thus, the merchant 124 when seeing the same receipt on his or her computing device 124 as the user 102 is displaying on a mobile computing device 104 is able to confirm that this user 102 paid for the good or service 108 indicated on the receipt.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A computer-implemented method comprising:
under control of a network-accessible point-of-sale (POS) device assigned to a merchant location but located remote from the merchant location, the network-accessible POS device configured with executable instructions,
receiving a selection of a good or service available at the merchant location, the selection made by a user of a mobile computing device while the goods and services available at the merchant are displayed on the mobile computing device and while the user and the mobile computing device are located at the merchant location;
receiving payment information from the mobile computing device, the payment information entered by the user into the mobile computing device to pay for the good or service;
presenting the payment information to a payment processor;
receiving confirmation from the payment processor that the payment information is associated with sufficient funds to pay for the good or service;
responsive to receiving the confirmation, generating a receipt that includes validation data based at least in part on seed information provided by a merchant operating the merchant location and an indication of the good or service; and
sending the receipt to the mobile computing device for display by the user of the mobile computing device to the merchant as evidence of payment for the good or service.

2. A computer-implemented method comprising:
under control of a network-accessible point-of-sale (POS) device assigned to a merchant location but located remote from the merchant location, the network-accessible POS device configured with executable instructions,
receiving a scan of a tag associated with a good or service available at the merchant location, the scan generated by a mobile computing device while a user of the mobile computing device and the mobile computing device are located at the merchant location;
receiving a user identifier that uniquely identifies the user of the mobile computing device;
using the user identifier to obtain previously stored payment information associated with the user to pay for the good or service;
presenting the payment information to a payment processor;
receiving confirmation from the payment processor that the payment information is associated with sufficient funds to pay for the good or service;
responsive to receiving the confirmation, generating a receipt that identifies the good or service; and
sending the receipt to the mobile computing device and to a computing device of a merchant operating the merchant location so that matching the receipt on the computing device of the merchant with the receipt on the mobile computing device to provides evidence of payment for the good or service.

3. A network-accessible point-of-sale (POS) device comprising:
one or more processors;
a network interface;
computer-readable media coupled to the one or more processors, the computer-readable media comprising:
a merchant location assignment module configured to associate the POS device with a merchant location remote from a physical location of the POS device;
a purchase module configured to receive, via the network interface, a purchase request from a customer-operated device located at the merchant location, the purchase request comprising payment information and an identification of a good or service;
a payment module configured to provide payment information to a payment processor and receive an authorization from the payment processor to fulfill the purchase request; and
a receipt generation module configured to generate a receipt evidencing the authorization from the payment processor and identifying the good or service.

4. The POS device as recited in claim 3, wherein the merchant location assignment module exclusively associates the POS device with the merchant location.

5. The POS device as recited in claim 3, wherein the merchant location assignment module associates the POS device with the merchant location for a time period based at least in part on a volume of transactions occurring or estimated to occur at the merchant location during the time period.

6. The POS device as recited in claim 3, wherein the merchant location assignment module establishes a secure connection between the POS device and a merchant network maintained by a merchant operating the merchant location so that the POS device functions as a part of the merchant network.

7. The POS device as recited in claim 3, wherein the payment information comprises payment information entered by a user of a customer-operated device at a time of the purchase request, payment information previously stored in a memory of the customer-operated device, or payment information available via a network and associated with the customer-operated device by a user identifier stored in a memory of the customer-operated device.

8. The POS device as recited in claim 3, wherein the identification of the good or service comprises a scan generated by the customer-operated device of a tag associated with the good or service, a selection of the good or service from a list displayed on the customer-operated device, or a code entered into the customer-operated device.

9. The POS device as recited in claim 3, wherein the receipt generation module sends the receipt to the customer-operated device and the receipt includes validation data based at least in part on information provided by a merchant associated with the merchant location.

10. The POS device as recited in claim 9, wherein the information is changed at a frequency specified by the merchant.

11. The POS device as recited in claim 3, wherein the receipt generation module sends the receipt to the customer-operated device and to a computing device of a merchant operating the merchant location.

12. The POS device as recited in claim 12, wherein the computer-readable media further comprises a security module configured to receive an indication of a location of the customer-operated device, compare the location of the customer-operated device to the merchant location, and when the location of the customer-operated device is more than a threshold distance from the merchant location prevent the customer-operated device from completing a purchase with a merchant operating the merchant location.

13. One or more computer-readable media storing computer-executable instructions stored at least partly on a network-accessible computing device located remote from a merchant location and uniquely associated with the merchant location, the computer-executable instructions configured to cause one or more processors of the network-accessible computing device to perform acts comprising:
receiving a purchase request via a network from a customer-operated device at the merchant location, the purchase request comprising payment information and identification of a good or service;
sending the payment information to a payment processor;
receiving authorization from the payment processor;
generating receipt data evidencing receipt of payment and identifying the good or service; and
sending the receipt data via the network to the customer-operated device.

14. The computer-readable storage media as recited in claim 13, wherein the customer-operated device comprises a mobile computing device associated with a customer.

15. The computer-readable storage media as recited in claim 13, wherein the customer-operated device comprises a mobile computing device maintained by the merchant at the merchant location for use by customers.

16. The computer-readable storage media as recited in claim 13, wherein the identification of the good or service comprises a code entered into the customer-operated device, the code designated by a merchant operating the merchant location as corresponding to the good or service.

17. The computer-readable storage media as recited in claim 13, wherein the payment information comprises a credit card number, a debit card number, a bank routing number, or a prepaid account identifier of a prepaid account associated with the merchant location.

18. The computer-readable storage media as recited in claim 13, wherein sending the payment information to the payment processor comprises sending payment information using an application programming interface (API) associated with the payment processor, the payment processor identified at least in part by the payment information.

19. The computer-readable storage media as recited in claim 13, wherein generating the receipt data comprises generating a receipt that includes validation data indicating authenticity of the receipt.

20. The computer-readable storage media as recited in claim 13, wherein sending the receipt data further comprises sending the receipt data via the network to a computing device of a merchant associated with the merchant location.

21. A computer-implemented method comprising:
under control of a mobile computing device configured with executable instructions, receiving, from a user of the mobile computing device at a merchant location, an identity of a good or service available from a merchant at the merchant location;
receiving an instruction from the user to send, via a network, the identity of the good or service and payment information to a network-accessible point-of-sale (POS) device associated with the merchant location and located remote from the merchant location; and
responsive to receiving authorization from the network-accessible POS device, causing display of a receipt on the mobile computing device, the receipt received via the network from the POS device and indicating that a user associated with the mobile device has paid for the identified good or service, wherein the receipt when displayed to the merchant and validated by the merchant results in the user receiving the good or service from the merchant.

22. The method as recited in claim 21, wherein receiving the identity comprises receiving an image of a tag associated with the good or service captured using a camera of the mobile computing device.

23. The method as recited in claim 21, wherein the mobile computing device comprises a smart phone, a tablet computer, or a personal digital assistant.

24. The method as recited in claim 21, wherein the network comprises a wireless network.

25. The method as recited in claim 21, wherein a timing of the causing display of the receipt on the mobile computing device is selected by the user associated with the mobile computing device.

26. The method as recited in claim 21, wherein the receipt enables the merchant to identify a match between the receipt displayed on the mobile computing device and a receipt displayed on a computing device of the merchant.

27. The method as recited in claim 21 further comprising receiving an indication to invalidate the receipt so that the receipt is no longer valid for the good or service.
